(19) United States
(12) Patent Application Publication
(10) Pub. No.: US 2004/0125977 A1
(43) Pub. Date: Jul. 1, 2004

(54) Headphone with an automatic reeling device for a jack wire

(76) Inventors: Chang-Ning Hong, Kaohsiung (TW); Qui-Ching Hou, Kaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/736,033

(22) Filed: Dec. 15, 2003

(30) Foreign Application Priority Data
Dec. 13, 2002 (TW) 091220230

(51) Int. Cl. H04R 25/00

(52) U.S. Cl. 381/376; 381/374

(57) ABSTRACT

A headphone with an automatic reeling device for a jack wire has a headband with two earphones, a reeling device installed inside one of the two earphones and a jack wire. The reeling device has a stationary disk, a rotating disk with a wire reel rotatably abutting the stationary disk, a coil spring mounted between the stationary disk and the rotating disk and a push button detachable engaging the rotating disk. The jack wire is wound around the wire reel on the rotating disk. By pressing the push button, the rotating disk is released, and the coil spring provides a restitution force to rotate the rotating disk and retract the jack wire into the earphone.

### BACKGROUND OF THE INVENTION

1. Field of the Invention

The invention relates to a headphone, and particularly to a headphone having an automatic reeling device to retract and hold a jack wire conveniently.

2. Description of Related Art

Conventional headphones are adapted to be worn on a person's ears to play sounds privately to avoid interference from the outside environment. A conventional headphone usually contains a head band with two ends, two ear-cups attached respectively to the two ends of the head band, two speakers installed respectively inside the two ear-cups and a jack wire attached to one ear-cup to connect to a player.

When the headphone is not used, the jack wire is usually wound on the headband so that the headphone does not have a neat appearance. Additionally, the jack wire easily tangles with other objects nearby and can be snagged to cause breaks especially at joints between the jack wire and the ear-cup. Therefore, the headphone is not convenient to use and can be easily damaged.

The present invention has arisen to provide a headphone with an automatic reeling device for the jack wire to obviate the drawbacks of the conventional clotheshorse.

### SUMMARY OF THE INVENTION

A main objective of the present invention is to provide a headphone with an automatic reeling device that retracts a jack wire automatically.

Further benefits and advantages of the present invention will become apparent after a careful reading of the detailed description when taken in conjunction with the drawings.

### BRIEF DESCRIPTION OF THE DRAWINGS

FIG. 1 is an exploded perspective view of a headphone with an automatic reeling device for a jack wire in accordance with the present invention;

FIG. 2 is an enlarged exploded perspective view of the reeling device in the headphone in FIG. 1;

FIG. 3 is an operational cross-sectional front plane view of the reeling device; and

FIG. 4 is a cross-sectional side plane view of the headphone showing a locking device installed in the reeling device.

### DETAILED DESCRIPTION OF THE PREFERRED EMBODIMENT

A headphone with a reeling device for a jack wire in accordance with the present invention comprises a headband, two earphones and a reeling device installed inside one of the two ear-cups to automatically reel in the jack wire.

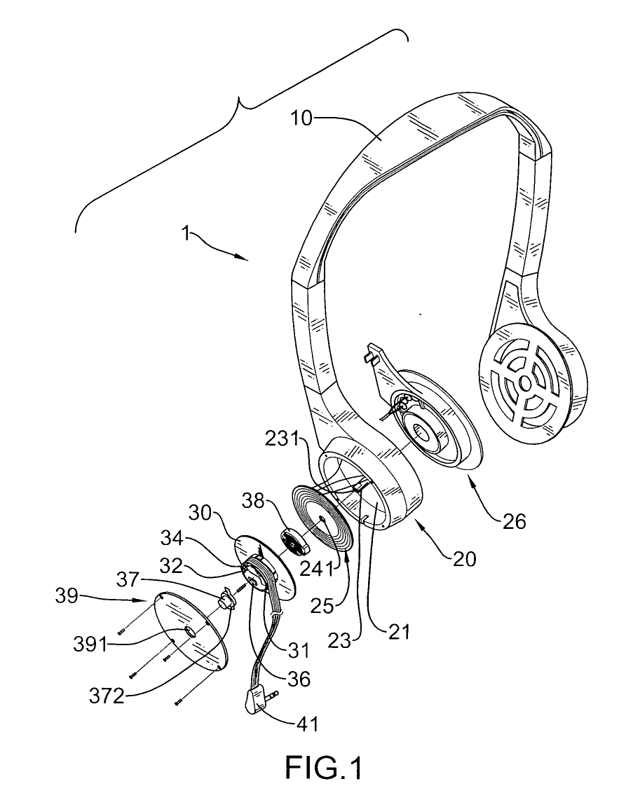

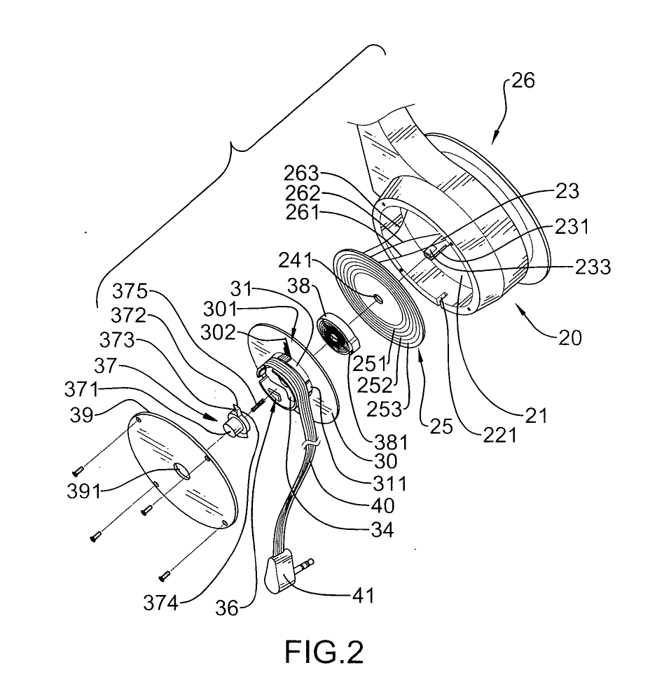

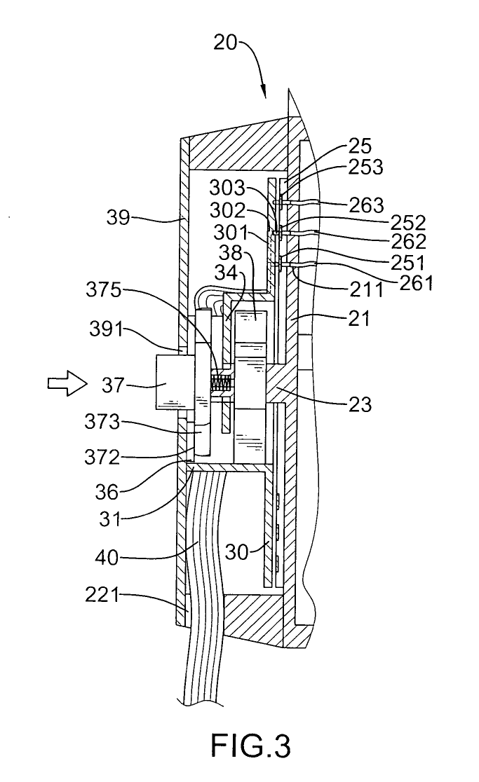

With reference to FIGS. 1 to 3, a preferred embodiment headphone with a reeling device for a jack wire in accordance with the present invention of the headphone (1) comprises a headband (10), two earphones (20), a reeling device (not numbered) and a jack wire (40). The headband (10) has two ends (not numbered). The two earphones (20) are electrically attached respectively to the two ends of the headband (10). The reeling device is installed inside one of the two earphones (20). The jack wire (40) is wound around the reeling device.

Each earphone (20) is a hollow cylinder (not numbered) with an inner end (not numbered), an outer end (not numbered), an inner cover (26), a middle plate (21), an outer cover (39) and an audio output device (not numbered) attached to the inner cover (26) to broadcast sounds. The inner cover is attached to the inner end of the earphone (20).

The middle plate (21) is formed in the hollow cylinder and has an edge (not numbered), a central post (23), multiple wire holes (211) and a wire slot (221). The central post (23) has an outer periphery (not numbered), a distal end (not numbered), a positioning slot (231), a spring recess (not numbered), two opposite flat portions (233) and a spring (375). The distal end extends toward the outer cover (39). The positioning slot (231) is defined axially in the distal end of the central post (23). The spring recess (not numbered) is defined in the distal end of the central post (23) and communicates with the positioning slot (231). The two opposite flat portions (233) are defined on the outer periphery of the central post (23) at the distal end. The spring (375) is mounted in and protrudes from the spring recess. The multiple wire holes (211) are defined through the middle plate (21), and the wire slot (221) is defined in the edge that abuts the outer cover (39) on the hollow cylinder.

The reeling device is mounted on the middle plate (21) and composed of a stationary disk (25), a coil spring (38), a rotating disk (30) and a push button (37). The stationary disk (25) has an outer surface (not numbered), an inner surface (not numbered), a central through hole (241), multiple circular contacts (251, 252, 253), and multiple conductive wires (261, 262, 263). The through hole (241) is defined in the stationary disk (25) to mount the stationary disk (25) on the middle plate (21) by penetrating the central post (23). Thereby, the stationary disk (25) is mounted inside the earphone (20). The multiple circular contacts are a left track contact (251), a ground contact (252) and a right track contact (253) are sequentially arranged on the outer surface of the stationary disk from inner to outside. The multiple conductive wires (261, 262, 263) are a left track wire (261), a ground wire (262) and a right track wire (263) connected respectively to the left track contact (251), the ground contact (252) and the right track contact (253). The multiple conductive wires (261, 262, 263) extend through the stationary disk (25), pass through the wire holes (211) in the middle plate (21) and connect to the audio output device on the inner cover (26).

The rotating disk (30) is rotatably mounted on the central post (23), abuts the stationary disk (25) and has an outer surface, an inner surface facing the stationary disk (25), a central through hole (not numbered), an inner edge (not numbered) and a hollow wire reel (31).

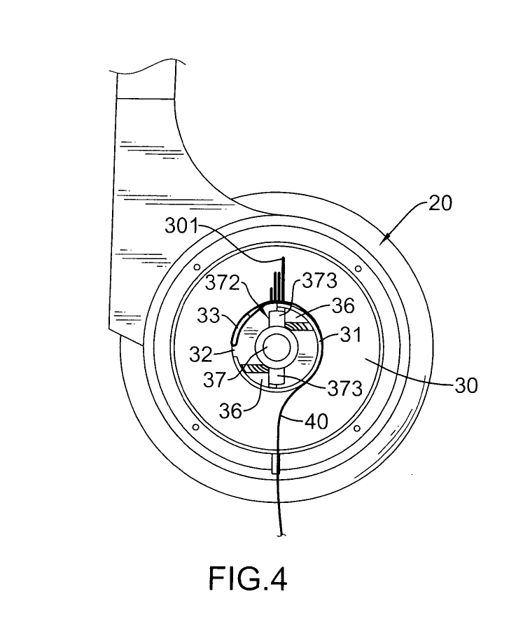

With further reference to FIG. 4, the wire reel (31) is a hollow cylinder (not numbered), is formed concentrically on the inner edge, extends from the outer surface and has an inner segment (not numbered), an outer segment (not numbered), a dividing plate (34) and two longitudinal slots (32). The dividing plate (34) has a through hole (not numbered), an outer surface (not numbered) and two stop blocks (36) and forms the inner segment and the outer segment inside the hollow cylinder. The through hole in the dividing plate (34) is formed concentrically with the through hole in the rotating disk (30).

The two longitudinal slots (32) are defined in the outer segment to define an attaching post (33) to which the jack wire (40) is connected. The outer segment has an inner wall, and the two stop blocks (36) are formed on the inner wall to extend inward. The inner segment accommodates the coil spring (38) and has a spring slot (311) defined in the inner segment..

The outer surface of the rotating disk (30) has multiple grooves (301) that extend out from the wire reel (31). Each groove (301) has a distal end (not numbered) and a lead hole (302) defined through the rotating disk (30) at the distal end.

The coil spring (38) is mounted inside the inner segment of the hollow wire reel (31) and has a stationary end (not numbered) and a hooked end (381). The stationary end engages the positioning slit (231) in the central post (23), and the hooked end (381) engages the spring slot (311) in the hollow wire reel (31). Thereby, the coil spring (38) provides a restitution force to the rotating disk (30).

The push button (37) is movably mounted on dividing plate (34) in the wire reel (31) and has an outer surface, a distal end (not numbered), a proximal end (not numbered), a post recess (not shown), a flange (not numbered), an axial stub (371) and two radial stops (372). The post recess is defined at the proximal end of the push button (37) to match with the distal end of the central portion (23). Wherein, the flat portions (233) on the distal end allow the push button (37) moving axially but forbid the push button (37) rotating relative to the central post (23) on the stationary disk (25). The flange is formed on and extends out radially from the distal end. The radial stops (372) are formed on and extend out radially from the flange and detachably engage the stop blocks (36) inside the wire reel (31). Each radial stop (372) has an inclined edge (373) and a vertical edge (374). The inclined edge (373) enables the stop block (36) to slide over the radial stop (372) when the rotating disk (30) rotates to allow the jack wire (40) to wound off the wire reel (31). The vertical edge (374) stops the radial stop (372) when the rotating disk (30) rotates in a direction to wind the jack wire (40) onto the wire reel (31). Therefore, the rotating disk (30) is unidirectional. A spring (375) is mounted in the spring recess on the central post (23) and partially emerges out of the spring recess to abut the push button (37).

The jack wire (40) has two ends, one end is firmly looped on the attaching post (33) on the hollow wire reel (31), and the other end is attached to a jack (41) to connect to an audio player. The jack wire (40) is composed of four wires (not numbered). The wires are branched to extend respectively into the grooves (301) on the rotating disk (30). Then, the wires penetrate through the lead holes (302) on the rotating disk (30), and each wire has a contact (303) to connect to one of the multiple circular contacts (251, 252, 253) by the contact (303).

The outer cover (39) is detachably mounted on the outer end of the earphone (20) by means of screws to hold the reeling device inside the earphone (20) and has a central button hole (391) to allow the push button (37) to protrude out of the earphone (20).

When the headphone is operated, the jack wire (40) is pulled out through the wire slot (221) in the earphone (20) to rotate the rotating disk (30). The stop block (36) slides over the inclined edge (373) to allow the rotating disk (30) to rotate. Meanwhile, the coil spring (38) is wound tightly and stores a restitution force until the jack wire (40) is not drawn out anymore. The stop block (36) engages the vertical edge (374) when the coil spring (38) attempts to wind the jack wire (40) back onto the wire reel (31). When the spring (375) is fully extended between the central post (23) and the push button (37), the radial stop (372) on the push button (37) engages the stop block (36) on the rotating disk (30) to hold the rotating disk (30) in place. To rewind the jack wire (40) onto the wire reel (31), the push button (37) is pressed, and the spring (375) is compressed to allow the radial stop (372) move axially to disengage from the stop block (36). Meanwhile, the restitution force in the coil spring (38) rotates the rotating disk (30) in the reverse direction to rewind the jack wire (40) onto the wire reel (31) automatically.

Consequently, the jack wire (40) can be rewound into the earphone (20) by simply pressing the push button (37). Therefore, the jack wire (40) is no longer exposed outside to tangle with other object nearby or itself when the headphone is not in use and the headphone has a neat appearance.

Although the invention has been explained in relation to its preferred embodiment, many other possible modifications and variations can be made without departing from the spirit and scope of the invention as hereinafter claimed.

What is claimed is:

1. A headphone with an automatic reeling device for a jack wire, the headphone comprising:
a headband (10) with two ends;
two earphones (20) respectively attached to the two ends of the headband (10);
a reeling device installed inside one of the two earphones (20); and
a jack wire (40) wound around the reeling device;
wherein the improvements of the headphone comprise:
the earphone (20) accommodating the reeling device and being a hollow cylinder with an inner end, an outer end, an inner cover (26), a middle plate (21) formed in the hollow cylinder, an outer cover (39), an audio output device attached to the inner cover (26) and a wire slot (221) defined in the hollow cylinder;
the inner cover (26) attached to the inner end of the earphone (20);
the middle plate (21) having a central post (23) with a distal end, a positioning slot (231) defined axially in the distal end, a spring recess defined in the distal end and communicating with the positioning slot (231), a spring (375) mounted in and protruding from the spring recess, multiple wire holes (211) defined through the middle plate (21);
the reeling device mounted on the middle plate (21) and having:
a stationary disk (25) mounted on the middle plate (21) and electrically connected to the audio output device;
a rotating disk (30) with a wire reel (31) rotatably mounted on the stationary disk (25), wherein the jack wire (40) is wound around the wire reel (31);
a coil spring (38) mounted between the stationary disk (25) and the rotating disk (30) to provide a restitution force to the rotating disk (30); and
a push button (37) movably mounted on the central post (23) and pushed by the spring (375) on the central post (23), wherein the push button (37) move along the central post (23) axially and is kept from rotation relative to the central post (23); and
the outer cover (39) mounted on the outer end of earphone (20) to hold the reeling device inside the earphone (20).

2. The headphone with an automatic reeling device as claimed in claim 1, wherein the stationary disk (25) comprising
an outer surface;
an inner surface;
a through hole (241) through which the central post (23) extends;
multiple circular contacts (251, 252, 253) being a left track contact (251), two ground contacts (252) and a right track contact (253) sequentially arranged on the outer surface of the stationary disk (25) inside out; and
multiple conductive wires (261, 262, 263) being a left track wire (261), two ground wires (262) and a right track wire (263) respectively connected to the left track contact (251), the two ground contacts (252) and the right track contact (253), the multiple conductive wires (261, 262, 263) extending through the stationary disk (25) and the middle plate (21) to connect to the audio output device on the inner cover (26).

3. The headphone with an automatic reeling device as claimed in claim 1, wherein the rotating disk (30) is rotatably mounted on the central post (23), abuts the stationary disk (25) and comprises
a through hole defined in the rotating disk (30);
an outer surface;
an inner surface facing the stationary disk (25);
the wire reel (31) being a hollow cylinder, formed concentrically on the outer surface and comprising
an inner segment;
an outer segment with an inner periphery;
a dividing plate (34) having a through hole formed concentrically with the through hole in the rotating disk (30), wherein the dividing plate (34) extends inward from the hollow cylinder to define the inner segment and the outer segment inside the hollow cylinder, wherein the inner segment accommodates the coil spring (38);
two stop blocks (36) formed on the inner periphery of the outer segment to detachably engage with the push button (37); and
two longitudinal slots (32) defined in the outer segment to define an attaching post (33) to which the jack wire (40) is connected.

4. The headphone with an automatic reeling device as claimed in claim 3, wherein the inner segment has a spring slot (311).

5. The headphone with an automatic reeling device as claimed in claim 3, wherein the rotating disk (30) has multiple grooves (301) defined in the outer surface of the rotating disk (30) and extending out from the wire reel (31);
each groove (301) has a distal end and a lead hole (302) defined through the rotating disk (30) at the distal end;
wherein the jack wire (40) is composed of multiple wires and the wires extend respectively into the multiple grooves (301).

6. The headphone with an automatic reeling device as claimed in claim 4, wherein the rotating disk (30) has multiple grooves (301) defined in the outer surface of the rotating disk (30) and extending out from the wire reel (31);
each groove (301) has a distal end and a lead hole (302) defined through the rotating disk (30) at the distal end; and
wherein the jack wire (40) is composed of multiple wires and the wires extend respectively into the multiple grooves (301).

7. The headphone with an automatic reeling device as claimed in claim 3, wherein the push button (37) has
an outer surface;
a distal end;
a proximal end;
a flange formed on and extending out radially from the distal end;
an axial stub (371) with an outer periphery; and
two radial stops (372) formed on and extend out radially from the flange and detachably engage the stop block (36) on the dividing plate (34);
wherein each radial stop (372) has an inclined face (373) and a vertical face (374).

8. The headphone with an automatic reeling device as claimed in claim 5, wherein the push button (37) has
an outer surface;
a distal end;
a proximal end;
a flange formed on and extending out radially from the distal end;
a stub (371) with an outer periphery; and
two radial stops (372) formed on and extend out radially from the flange and detachably engage the stop block (36) on the dividing plate (34);
wherein each radial stop (372) has an inclined face (373) and a vertical face (374).

9. The headphone with an automatic reeling device as claimed in claim 8, wherein two opposite flat portions are formed at the distal end of the central post (23); and
a post recess defined in the proximal end of the push button (37) to match with the distal end of the central post (23) to allow the push button (37) moving axially along the central post (23);
wherein, the opposite flat portions of the central post (23) prevent the push button (37) from rotating with the rotating disk (30).
